(19) United States
(12) Patent Application Publication
(10) Pub. No.: US 2006/0121773 A1
(43) Pub. Date: Jun. 8, 2006

(54) High-voltage wire connecting structure and high-voltage wire connecting method

(75) Inventors: Hidehiro Ichikawa, Toyota-shi (JP); Shigemi Hashizawa, Toyota-shi (JP)

Correspondence Address: SUGHRUE MION, PLLC, 2100 PENNSYLVANIA AVENUE, N.W., SUITE 800, WASHINGTON, DC, 20037, US

(73) Assignee: YAZAKI CORPORATION

(21) Appl. No.: 11/285,310

(22) Filed: Nov. 23, 2005

(30) Foreign Application Priority Data
Nov. 26, 2004 (JP) P.2004-342851

(51) Int. Cl. H01R 4/24

(52) U.S. Cl. 439/408

(57) ABSTRACT

A portion of a conductor 1a of each high-voltage wire, exposed by removing an insulating sheath 1b, is formed into a flat plate-like terminal 2 of an integral construction. A portion of a conductor 3a of each of the other high-voltage wires 3, exposed from an insulating sheath 3b, is formed into a flat plate-like terminal 4. Each mating pair of flat plate-like terminals 2 and 4 are connected together by welding or melt adhesion, and are received within an insulating casing 5, and are sealed by a hot-melt adhesive 6 filled in the insulating casing 5.

### BACKGROUND OF THE INVENTION

1. Field of the Invention

This invention relates to a high-voltage wire connecting structure and a high-voltage wire connecting method, in which a conductor, composed of a number of conductor wires, is connected to a conductor of a mating connecting member, and besides the waterproofness of the connected portions is secured.

2. Related Art

For example, in the case of connecting a high-voltage wire, used in electric wiring of a vehicle, to a mating connecting member (e.g., another high-voltage wire), it is necessary to provide a structure by which an electrically-contacted condition of the connected portions can be kept good even upon application of vibrations or others.

FIG. 5 shows one conventional high-voltage wire connecting structure. As shown in FIG. 5, a male terminal 51 (which is provided within a connector) is connected to an end portion of a conductor of a high-voltage wire 50. A female terminal 52 (which is provided within another connector) is connected to an end portion of a conductor of a mating connecting member. The female terminal 52 has a terminal insertion chamber for receiving the male terminal 51, and leaf springs 53 are provided in a projecting manner within this terminal insertion chamber. When the male terminal 51 and the female terminals 52 are connected together upon fitting of the two connectors together, the male terminal 51 and the female terminal 52 are press-contacted with each other by spring forces of the leaf springs 53. Namely, the strong press-contacting force to contact the male and female terminals 51 and 52 with each other is secured by the spring forces so that the electrically-contacted condition will not become unstable (the increase of a contact resistant or incomplete contact) even upon application of vibrations or others.

For imparting a waterproof nature to the above conventional connecting structure, there have heretofore been used a method of sealing the connected portions of the male and female terminals 51 and 52 by a molding resin (see, for example, JP-A-2002-315130), a method of potting the connected portions by an epoxy resin or a silicone resin, or a method of sealing the connected portions by the use of a housing and a rubber plug.

However, in the above conventional waterproof structure of connecting the high-voltage wire 50, the number of the component parts was large since the male terminal 51 and the female terminal 52 were used as the connecting structure. And besides, in the case of effecting the sealing by the molding resin and also in the case of effecting the sealing by the housing and the rubber plug, large-scale facilities and process were necessary. Furthermore, in the case of effecting the potting by the epoxy resin or the silicone resin, it took much time for the molten resin to be cured, so that the productivity was low.

### SUMMARY OF THE INVENTION

Therefore, this invention has been made in order to solve the above problems, and an object of the invention is to provide a high-voltage wire connecting structure and a high-voltage wire connecting method, in which the highly-reliable electrically-contacted condition and waterproof performance can be secured with a smaller number of component parts.

According to the present invention, there is provided a structure of connecting a high-voltage wire including a conductor and an insulating sheath covering the conductor, wherein the conductor is composed of a number of conductor wires, and is connected to a conductor of a mating connecting member; characterized in that a portion of the conductor of the high-voltage wire, exposed by removing the insulating sheath, is formed into a flat plate-like terminal of an integral construction; and a portion of the conductor of the mating connecting member, exposed from an insulating sheath, is formed into a flat plate-like terminal; and the two flat plate-like terminals are connected together by melt connection means; and the two flat plate-like terminals thus connected together are sealed by a sealing material having insulating and water-stop properties.

The high-voltage wire connecting structure of the present invention is provided in that the two flat plate-like terminals, connected together, are received within an insulating casing, and are sealed by the sealing material filled in the insulating casing.

The high-voltage wire connecting structure of the present invention is provided in that the sealing material is a hot-melt adhesive.

According to the present invention, there is provided a method of connecting a high-voltage wire including a conductor and an insulating sheath covering the conductor, wherein the conductor is composed of a number of conductor wires, and is connected to a conductor of a mating connecting member; characterized in that a portion of the conductor of the high-voltage wire is exposed by removing the insulating sheath, and is processed into a flat plate-like terminal of an integral construction; and in case a portion of the conductor of the mating connecting member, exposed from an insulating sheath, is not a flat plate-like terminal, the portion is processed into the flat plate-like terminal of an integral construction; and the two flat plate-like terminals are connected together by melt connection means; and the two flat plate-like terminals thus connected together are sealed by a sealing material having insulating and water-stop properties.

According to the present invention, the conductor of the high-voltage wire itself is formed into the flat plate-like terminal, and the conductor of the mating connecting member is also formed into the flat plate-like terminal, and the two terminals are connected together by the melt connection means. Therefore, the two terminals are electrically connected together without the use of a male terminal and a female terminal as employed in the conventional structure. The only part or material, used here, is the sealing material for securing the waterproofness of the two flat plate-like terminals connected together. And besides, the two flat plate-like terminals are joined by welding or melt adhesion, and therefore the very firmly-connected condition can be obtained. Therefore, the highly-reliable electrically-contacted condition and waterproof performance can be secured with the smaller number of parts.

According to the present invention, it is only necessary to fill the sealing material in the insulating casing, and therefore large-scale facilities and process are not necessary. And besides, the sealing material, poured into the insulating casing, covers the entire outer peripheries of the two flat plate-like terminals, and therefore the two flat plate-like terminals are positively sealed.

According to the present invention, the hot-melt adhesive is rapidly cured, and therefore, the processing time is short, so that the productivity is high.

According to the present invention, the conductor of the high-voltage wire itself is formed into the flat plate-like terminal, and the conductor of the mating connecting member is also formed into the flat plate-like terminal, and the two terminals are connected together by the melt connection means. Therefore, the two terminals are electrically connected together without the use of a male terminal and a female terminal as employed in the conventional structure, and the highly-reliable electrically-contacted condition and waterproof performance can be secured with the smaller number of parts.

### BRIEF DESCRIPTION OF THE DRAWINGS

FIG. 1 is a perspective view of a preferred embodiment of a high-voltage wire connecting structure of the present invention.

FIG. 2 is a cross-sectional view of the high-voltage wire connecting structure of the above embodiment.

FIG. 3A is a perspective view of a high-voltage wire, used in the invention, showing a condition before its conductor is processed, and FIG. 3B is a perspective view of the high-voltage wire, showing a condition after the conductor is processed.

FIG. 4 is a cross-sectional view of another embodiment of a high-voltage wire connecting structure of the invention.

FIG. 5 is a perspective view showing a male terminal and a female terminal which are used in a conventional structure.

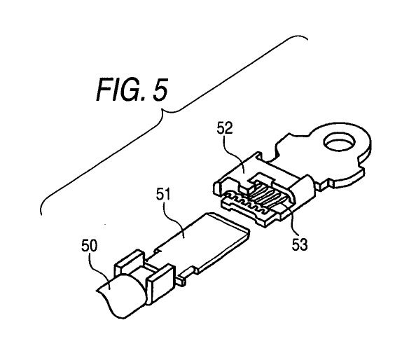

### DETAILED DESCRIPTION OF THE PREFERRED EMBODIMENTS

A preferred embodiment of the present invention will now be described with reference to the drawings.

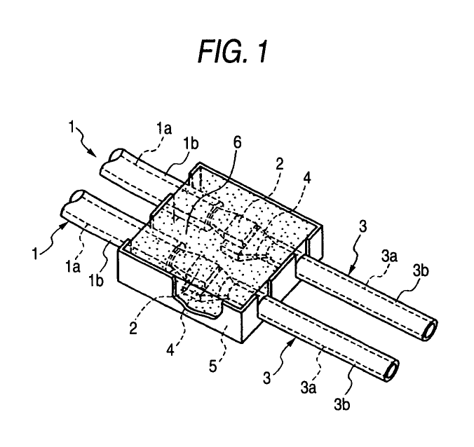

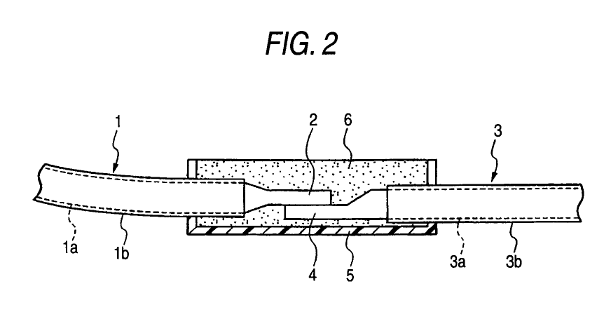

As shown in FIGS. 1 and 2, each of the two high-voltage wires 1 and 1 comprises the conductor 1a composed of a number of fine conductor wires twisted together, and a waterproof sheath 1b covering an outer periphery of the conductor 1a. The sheath 1b is removed from an end portion of the high-voltage wire 1, thereby exposing the conductor 1a. The exposed end portion of the conductor 1a is formed or processed by heat and pressure (using a thermocompression bonding apparatus or the like) into a flat plate-like terminal 2 of an integral construction.

Like the high-voltage wires 1, each of two other high-voltage wires 3 and 3 (serving as mating connecting members) comprises a conductor 3a composed of a number of fine conductor wires twisted together, and a waterproof sheath 3b covering an outer periphery of the conductor 3a. The sheath 3b is removed from an end portion of the high-voltage wire 3, thereby exposing the conductor 3a. The exposed end portion of the conductor 3a is formed or processed by heat and pressure (using a thermocompression bonding apparatus or the like) into a flat plate-like terminal 4 of an integral construction.

The flat plate-like terminals 2 of the high-voltage wires 1 are superposed respectively on the flat plate-like terminals 4 of the high-voltage wires 3, and in this condition each mating pair of superposed flat plate-like terminals 2 and 4 are connected together by melt connection means such as welding (e.g., resistance welding) or melt adhesion (e.g., thermal welding and ultrasonic welding).

The thus connected flat plate-like terminals 2 and 4 are received within a resin casing 5 having an open top. The resin casing 5 is filled with an hot-melt adhesive 6 (which is a sealing material) having insulating and water-stop properties. The flat plate-like terminals 2 and 4 are sealed by this hot-melt adhesive 6.

Next, a method of connecting the high-voltage wires 1 will be described.

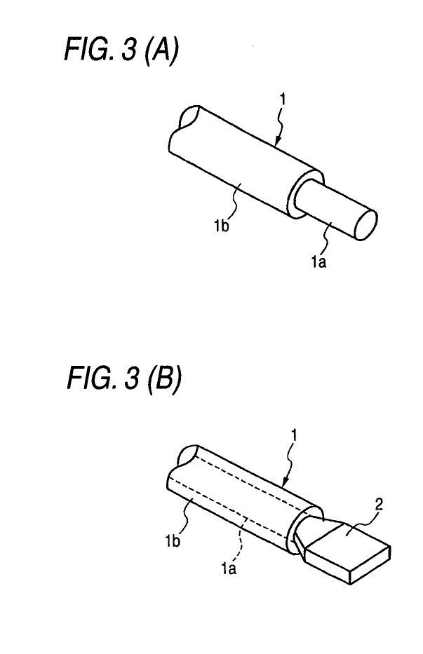

As shown in FIG. 3A, the sheath 1b is removed from the end portion of each high-voltage wire 1, thereby exposing the conductor 1a. Then, heat and pressure are applied to the exposed end portion of the conductor 1a by the use of a thermocompression bonding apparatus or the like. Then, this portion of the conductor 1a is formed or processed into the flat plate-like terminal 2 of an integral construction.

A similar processing is applied to the end portion of the conductor 3a of each high-voltage wire 3, thereby forming this end portion into the flat plate-like terminal 4.

Then, the flat plate-like terminals 2 of the high-voltage wires 1 are superposed respectively on the flat plate-like terminals 4 of the high-voltage wires 3, and in this condition each mating pair of superposed flat plate-like terminals 2 and 4 are connected together by melt connection means such as welding (e.g., resistance welding) or melt adhesion (e.g., thermal welding and ultrasonic welding).

Then, the thus connected flat plate-like terminals 2 and 4 are inserted into the resin casing 5, and are received therein. A molten hot-melt adhesive (sealing material) 6 is filled in the resin casing 5, and when this hot-melt adhesive 6 is cured, this connecting process is completed.

In the above structure of connecting the high-voltage wires 1 and the method of connecting the high-voltage wires 1, the end portion of the conductor 1a of each high-voltage wire 1 itself is formed into the flat plate-like terminal 2, while the end portion of the conductor of each high-voltage wire 3 is also formed into the flat plate-like terminal 4. Then, the flat plate-like terminals 2 and 4 are connected together by welding or melt adhesion. Thus, the two terminals 2 and 4 are electrically connected together without the use of male and female terminals as employed in the conventional structure, and the only part or material, used here, is the hot-melt adhesive 6 which is inevitably required for securing the waterproofness of the connected flat plate-like terminals 2 and 4. And besides, each mating pair of flat plate-like terminals 2 and 4 are joined by welding or melt adhesion, and therefore the very firmly-connected condition can be obtained. Therefore, the highly-reliable electrically-contacted condition and waterproof performance can be secured with the smaller number of parts.

Furthermore, each mating pair of flat plate-like terminals 2 and 4 are received within the insulating casing 5, and are sealed by the hot-melt adhesive 6 filled in this insulating casing 5. Therefore, it is only necessary to fill the hot-melt adhesive 6 in the insulating casing 5. Therefore, large-scale facilities and process are not necessary. Furthermore, the hot-melt adhesive 6, poured into the insulating casing 5, covers the entire outer peripheries of each mating pair of flat plate-like terminals 2 and 4, and therefore the flat plate-like terminals 2 and 4 are positively sealed.

The hot-melt adhesive 6 is used as the sealing material. This hot-melt adhesive 6 is rapidly cured, and therefore, the processing time is short, so that the productivity is high. Any other suitable material than the hot-melt adhesive 6 can be used in so far as it possesses insulating and water-stop properties.

In the above embodiment, the conductor 3a of each high-voltage wire (mating connecting member) 3 is composed of a number of fine conductor wires twisted together. However, in the case where the conductor 3a is composed of a single thick conductor wire (metal rod) of a round cross-section, the end portion of this conductor is formed into a flat plate-like terminal of an integral construction by a pressing operation, using a pressing machine or the like.

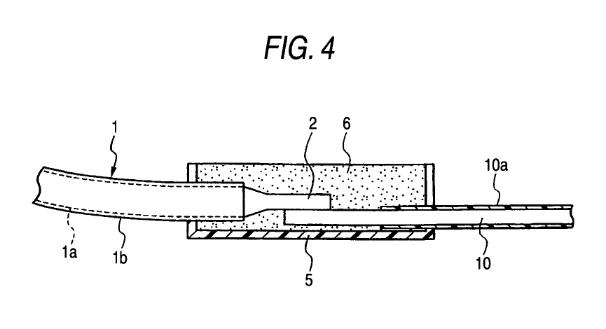

FIG. 4 is a cross-sectional view showing another embodiment of a high-voltage wire (3) connecting structure of the invention. In this embodiment, a mating connecting member is a bus bar 10 covered with a sheath 10a. The bus bar 10 has a flat plate-like shape, and therefore it is not necessary to provide the step of processing or forming an exposed end portion of the bus bar 10 into a flat plate-like terminal. The other construction is similar to that of the preceding embodiment, and therefore identical constituent portions are designated by identical reference numerals, respectively, and detailed explanation thereof is omitted here.

What is claimed is:

1. A structure of connecting a wire comprising:
a high-voltage wire having a conductor and an insulating sheath covering the conductor, the conductor including a number of conductor wires, and connected to a conductor of a mating high-voltage wire;
a first portion of said conductor of said high-voltage wire exposed by removing said insulating sheath, the first portion of the conductor formed into a flat plate-like terminal; and
a second portion of said conductor of said mating high-voltage wire exposed from an insulating sheath, the second portion of the conductor formed into a flat plate-like terminal;
wherein said first portion and the second portion are connected together by melt connection; and said first portion and second portion connected together are sealed by a sealing material having insulating and water-stop properties.

2. A high-voltage wire connecting structure according to claim 1, further comprising:
an insulating casing accommodating said first portion and the second portion connected together which are sealed by filing said sealing material filled therein.

3. A high-voltage wire connecting structure according to claim 1, wherein said sealing material is a hot-melt adhesive.

4. A method of connecting a high-voltage wire having a conductor and an insulating sheath covering the conductor, the conductor including a number of conductor wires, and connected to a conductor of a mating high-voltage wire, comprising the steps of;
processing a first portion of said conductor of said high-voltage wire, which is exposed by removing said insulating sheath to shape a flat plate-like terminal;
processing a second portion of said conductor of said mating high-voltage wire, which is exposed from an insulating sheath to shape a flat plate-like terminal if the second portion is not shape in the flat plate-like terminal;
connecting and said first portion and the second portion by melt connection;
searing the first portion and the second portion and said two connected together by a sealing material having insulating and water-stop properties.
